(19) United States
(12) Patent Application Publication
(10) Pub. No.: US 2012/0183821 A1
(43) Pub. Date: Jul. 19, 2012

(54) GALVANIC CELL HAVING A MULTIPART HOUSING HAVING AN ELASTIC ASSEMBLY SEAM

(75) Inventors: Tim Schaefer, Niedersachswerfen (DE); Andreas Gutsch, Luedinghausen (DE)

(73) Assignee: LI-TEC BATTERY GMBH, Kamenz (DE)

(21) Appl. No.: 13/202,815

(22) PCT Filed: Dec. 4, 2009
(86) PCT No.: PCT/EP2009/008685

§ 371 Date: Apr. 2, 2012

(30) Foreign Application Priority Data
Feb. 23, 2009 (DE) 10 2009 010 146.2

(51) Int. Cl. H01M 2/02; H01M 10/04; H01M 10/02

(52) U.S. Cl. 429/66; 29/623.2

(57) ABSTRACT

The invention relates to a galvanic cell (1) substantially prismatic in design, comprising an electrode stack (2) having at least one anode (3, 3a), one cathode (4, 4a), and one separator. The separator (5) is provided for at least partially receiving an electrolyte. The galvanic cell further comprises at least two housing parts (6, 7) at least partially enclosing the electrode stack. At least one assembly seam (8, 8a) connects the at least two housing parts at least in parts. The galvanic cell is characterized in that the at least one assembly seam is elastic in design.

The present invention relates to a galvanic cell for a battery. The invention is described in connection with rechargeable lithium-ion batteries for the supply of motor vehicle drives. It is to be pointed out that the invention can also be used independently of the type of construction of the galvanic cell, its chemistry and also independently of the type of drive which is supplied.

Rechargeable batteries having several galvanic cells for the supply of motor vehicle drives are known from the prior art. During the operation of the rechargeable battery in a vehicle, the galvanic cell ages. Mechanical stresses can have a damaging effect on some assemblies of the galvanic cell and can reduce their service life.

The invention is based on the problem of increasing the service life of a galvanic cell.

This problem is solved according to the invention by the subjects of the independent claims. Further developments of the invention, which are to be preferred, are the subject of the subclaims.

A galvanic cell according to the invention, substantially prismatic in design, has an electrode stack having at least one anode, one cathode, and one separator. The separator is provided for at least partially receiving an electrolyte. The galvanic cell further comprises at least two housing parts, at least partially enclosing the electrode stack. At least one assembly seam connects the at least two housing parts at least in parts. The galvanic cell is characterized in that the at least one assembly seam is expandable in design.

In the sense of the invention, a galvanic cell is understood to mean a device which also serves for the storage of chemical energy and for the emission of electrical energy. For this, the galvanic cell according to the invention has at least one electrode stack, which is enclosed by a multipart housing. The galvanic cell can also be configured to receive electrical energy on charging. One then speaks in terms of a secondary cell or an accumulator. Several galvanic cells can be connected to a battery in particular electrically in series- and/or parallel connection. Here, the several galvanic cells are arranged in particular touching each other.

In the sense of the invention, an electrode stack is understood to mean an arrangement which serves as an assembly of a galvanic cell also for the storage of chemical energy and for the emission of electrical energy. For this, the electrode stack has at least two electrodes, anode and cathode, and a separator, which at least partially receives the electrolyte. Preferably, at least one anode, one separator and one cathode are placed or respectively stacked one over the other, wherein the separator is arranged at least partially between the anode and cathode. This sequence can be repeated as desired within the electrode stack. Preferably, the layers are wound to form an electrode coil. The term “electrode stack” will also be used below for electrode coil.

Before the emission of electrical energy, stored chemical energy is converted into electrical energy. This conversion entails losses. During charging, the electrical energy supplied to the electrode stack or respectively to the galvanic cell is converted into chemical energy and stored.

On the removal or supply of electrical energy, electric currents flow in the electrode stack, which bring about a heat output. This heat output can lead to an increase in temperature of the electrode stack or respectively of the galvanic cell. As a result of the temperature increase, the electrode stack can expand.

Preferably, the electrode stack has several electrode pairs and separators. Particularly preferably, some electrodes are connected with each other in particular electrically. Preferably, the outer electrodes of the electrode stack have different polarity. Preferably, the electrode stack is block-shaped. Preferably, the normal vectors with the greatest amounts of a plate-shaped electrode and of the associated electrode stack are arranged in parallel.

In the sense of the invention, an anode is understood to mean an arrangement which on charging stores positively charged ions for example on interstitial sites. In so doing, the anode can expand. Also, the anode can expand as a result of heating. Preferably, the anode has an active anode mass and a current collector. Preferably, the current collector of the anode is constructed having thin walls, particularly preferably as a metal foil. Preferably, the current collector is constructed so as to be substantially rectangular.

In the sense of the invention, a cathode is understood to mean an arrangement which on discharging or respectively during the emission of electrical energy also receives electrons and positively charged ions. Preferably, the cathode has an active cathode mass and a current collector. Preferably, the current collector of the cathode is constructed having thin walls, particularly preferably as metal foil. The design of the cathode preferably corresponds substantially to the design of an anode of the electrode stack.

In the sense of the invention, a separator is understood to mean an arrangement which separates and spaces apart an anode and a cathode or respectively the active electrode masses thereof. The separator also receives the electrolyte at least partially. Preferably, a separator is constructed having thin walls, particularly preferably of polymer foil. Preferably, the design of the separator corresponds substantially to the design of an anode of the electrode stack. Preferably, the separator has a ceramic material.

In the sense of the invention, a housing part is understood to mean an arrangement which at least partially encloses the electrode stack. Preferably, an in particular thin-walled housing part has a three-dimensional design and/or at least one boundary edge. The design of a housing part is also adapted to the design of the electrode stack. Preferably, a housing part has at least in parts an electrically conductive material. Preferably, a housing part has copper, aluminium, high-grade steel and/or a thermosetting polymer. Preferably, a housing part is covered in parts with an in particular electrically insulating coating.

Preferably, several housing parts, in particular two housing parts, are configured such that they jointly predominantly enclose the electrode stack. Preferably, at least respectively one boundary edge of two housing parts run parallel at least in parts. Preferably, boundary edges, running parallel in parts, of different housing parts are separated by a narrow gap. Preferably, at least two housing parts are insulated electrically from each other.

In the sense of the invention, an expandable assembly seam is understood to mean and arrangement which connects several housing parts in particular in a materially bonded manner. Preferably, the expandable assembly seam is constructed elastically. Several housing parts can be connected by several separated assembly seams. Preferably, the at least one assembly seam is also produced by gluing, soldering or welding. Preferably, a joining method is used which produces an expandable assembly seam. The modulus of elasticity of the material of the at least one assembly seam is preferably less than the modulus of elasticity of the materials of the housing part. In particular, elastic restoring forces within the at least one expandable assembly seam also bring about a close enclosing of the electrode stack by the at least two housing parts.

The electrical conductivity of the material at least of one assembly seam is preferably distinctly less than the electrical conductivities of the materials of the housing parts. Preferably, at least one assembly seam has at least one thermosetting polymer. Particularly preferably, at least one assembly seam has an elastomer or rubber.

In so far as the electrode stack of a galvanic cell expands as a result of temperature increase, the storage of ions into an electrode and/or deposition of a substance on an electrode, the housing of the galvanic cell, in particular at least a region of an assembly seam, can at least intermittently yield to this expansion. Thus, forces which act on the layers of the electrode stack are reduced. A possible damage to a layer of the electrode stack as a result of a compressive stress is thus reduced. Thus, the galvanic efficiency of the electrode stack is largely maintained and the underlying problem is solved.

Further developments of the invention, which are to be preferred, are described below.

Advantageously, at least one anode and cathode of the electrode stack are connected, in an electrically and thermally conductive manner, at least in parts area by area with different housing parts, in particular in a force-fitting and/or form-fitting manner. Thus, both the anode and also the cathode can exchange electrical energy and/or thermal energy with the respective housing parts.

An electrode of a galvanic cell can be contacted with a so-called pole feedthrough. This pole feedthrough here usually penetrates the housing of a galvanic cell. The site of the penetration is to be sealed with respect to the environment. With an electrically conducting contact between an electrode and a housing part, however, a pole feedthrough can be dispensed with. Thus, a possible leakage site of the housing is advantageously avoided.

With a thermoconducting contact between an electrode and a housing part, thermal energy can be exchanged from the exterior with an electrode or respectively with the electrode stack. Thus, influence can be exerted on the temperature of the electrode or respectively of the electrode stack of a galvanic cell. In particular when the region of thermoconducting contact between an electrode and a housing part is configured covering a large area, greater thermal outputs can be exchanged with the electrode or respectively with the electrode stack.

Advantageously, at least one anode and one cathode of the electrode stack are constructed as housing parts. Preferably, the two outer electrodes of the electrode stack are constructed as housing parts. Preferably, these two outer electrodes have different polarity. With this construction of two electrodes, advantageously additional housing parts can be dispensed with. In this embodiment, at least one expandable assembly seam connects an anode with a cathode to form a closed housing around the remaining layers of the electrode stack. Here, the expandable assembly seam insulates the connected housing parts or respectively electrodes from each other.

Advantageously, the at least one assembly seam is designed to fail in a predetermined manner. With a corresponding construction of the at least one assembly seam, influence can be exerted on the extent of an excess pressure necessary for the failure of the assembly seam within the galvanic cell. In addition, the assembly seam is preferably constructed with a thin site or predetermined breaking point, so that influence can be exerted on the site of the failure of the at least one assembly seam. In addition, with corresponding construction of the at least one assembly seam, via the extent of a thin site or predetermined breaking point influence can be exerted on the size of the opening area after the failure of the at least one assembly seam.

Advantageously, a first contact region is arranged on a boundary surface of a housing part. A first contact region is electrically conductive and/or thermally conductive. With regard to the exchange of electrical energy or respectively thermal energy with the electrode stack, a housing also acts as a further resistance. With the said construction of two electrodes as housing parts, the electrical resistance and the thermal resistance can be reduced compared with a conventional embodiment of a galvanic cell. With this construction of the galvanic cell, the latter can be contacted advantageously via several and/or larger first contact regions in an electrically conductive and/or thermally conductive manner. Feedthroughs or respectively apertures of a housing part can be advantageously dispensed with.

Advantageously, after the joining or respectively enclosing of the electrode stack, the at least two housing parts are braced against each other. The at least two housing parts enclose the electrode stack in particular in a form-fitting manner. Here, the at least two housing parts lie closely against the electrode stack. Preferably, the at least two housing parts exert a predetermined pressure on the electrode stack. This pressure also brings it about that the different layers of the electrode stack stand securely on each other and in good electrical and thermal contact with the housing parts. The pressure of the housing parts also brings it about that the different layers of the electrode stack also exert frictional forces on each other. These frictional forces reduce undesired relative movements of individual layers, in particular as a result of vibrations. Thus, vibrations which occur during the operation of the galvanic cell are less able to impair the cohesion of the electrode stack. The bracing of the at least two housing parts brings it about that a gap widens between these at least two housing parts after removal or failure of the expandable assembly seam. In particular, elastic restoring forces within the at least one expandable assembly seam also bring about a close enclosing of the electrode stack by the at least two housing parts.

Advantageously, at least one of the housing parts is designed such that it has to be deformed for lying against the electrode stack or respectively for closing the housing. The deformation also brings about mechanical stresses and elastic restoring forces within this housing part. These stresses and restoring forces also lead to the housing part in the connection with the remaining housing being able to exert a force on the electrode stack. This force preferably acts perpendicularly onto at least one of the boundary surfaces of the electrode stack and in so doing presses the different layers of the electrode stack onto each other. The electrode stack rests here in particular against the remaining housing. Frictional forces between the individual layers preferably reduce a slipping of individual layers, in particular as a result of vibrations. This housing part is preferably also reinforced with corrugations or ribs, which increase the elastic restoring forces.

Advantageously, at least one measurement device, in particular a thermal element, is associated with a galvanic cell. The at least one measurement device determines in particular the temperature of the galvanic cell at a predetermined site and is provided in order to make available an associated measured value. Preferably, the at least one measurement device is arranged within the at least two housing parts. Preferably, the at least one measurement device determines a parameter of the electrode stack, which can give information about an undesired operating state, in particular overheating. Pressure and temperature are such parameters.

Advantageously at least one feed line to this measurement device within a housing part is connected with at least one second contact region. Preferably, a second contact region is part of the wall of a housing part. Several second contact regions are preferably insulated from each other and with respect to the remaining regions of the at least one housing part, but are themselves electrically conductive. Thus, the determined measured value can be picked up with contacting of the second contact regions of the at least one housing part. The carrying through in particular of connection cables can advantageously be dispensed with.

Advantageously a galvanic cell according to the invention is produced so that its at least two housing parts are braced against each other after joining. For this, the at least two housing parts are pressed together after their arranging around the electrode stack. For this, preferably a production arrangement is used, which permits an access to the boundary edges, which are to be connected, of the at least two housing parts. Preferably, the at least one expandable assembly seam is produced by gluing, soldering or welding. However, other joining methods are also suitable to connect the at least two housing parts elastically.

Advantageously, the space enclosed by the at least two housing parts is evacuated before the production of the at least one assembly seam. Preferably, the production of a galvanic cell according to the invention takes place at least intermittently within an evacuated space. Here, the term “evacuated” also includes a significantly reduced air pressure compared with the normal atmosphere. Preferably, the above-mentioned production arrangement is transferred into an evacuated region before the production of the at least one assembly seam. Only after completion of the assembly seam is the closed galvanic cell removed from the evacuated region again.

Advantageously, for enclosing the electrode stack at least one housing is used, which is able to be transferred into a tensioned state. Only in the tensioned state does the design of this housing part correspond to the design of the electrode stack. Preferably, the housing part in the tensioned state lies at least partially against the electrode stack. Preferably, for the production of a galvanic cell according to the invention, a production aid is used which can bring about the transfer of the at least one housing part into a tensioned state. Preferably, the compressing of the at least two housing parts and the transferring of the at least one housing part into a tensioned state take place with the same production aid. It is insignificant here whether the at least two housing parts are only compressed around the electrode stack, or only the at least one housing part is transferred into its tensioned state.

Advantageously, a galvanic cell according to the invention is operated so that in particular in the case of a predetermined excess pressure within the galvanic cell, a region of the at least one assembly seam fails. For this, the at least one assembly seam preferably has at least one thin site. A thin site is arranged in particular in a region of the at least one assembly seam, which prevents an exit of a larger quantity of electrolyte. In particular, a thin site is arranged in a region of the galvanic cell, which during the operation is arranged in an upper region of an associated battery. Here, the length of the thin site is preferably dimensioned so that the excess pressure is not abruptly reduced. However, according to the circumstances of the operation of an associated battery, it may depend on as efficient a reduction of a possible excess pressure as possible. In this case, the at least one thin site is dimensioned to be rather longer and possibly also constructed along several boundary edges of the at least two housing parts. Preferably, an expandable assembly seam at least partially tears or breaks on overloading.

Advantageously, a galvanic cell according to the invention is operated so that thermal energy is removed from at least one housing part, in particular on exceeding a predetermined maximum operating temperature of the galvanic cell. For this, the galvanic cell according to the invention is preferably in thermally conducting contact with a heat removal arrangement. This heat removal arrangement can be part of a superordinate battery. Preferably, for switching a switchable heat removal arrangement, the measured value provided by a measurement device of the galvanic cell, in particular the temperature of the galvanic cell, is used.

Further advantages, features and possibilities for application of the present invention will emerge from the following description in connection with the figures, in which are shown:

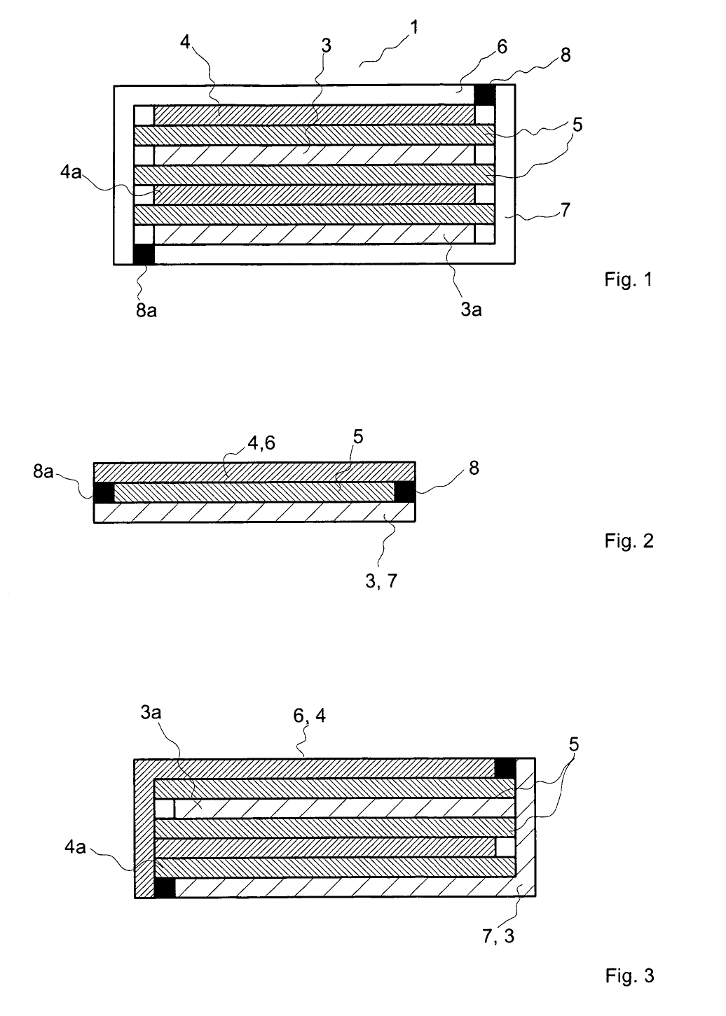

FIG. 1 an embodiment of a galvanic cell according to the invention, in section,

FIG. 2 a further development of a galvanic cell according to the invention, in section,

FIG. 3 a second further development of a galvanic cell according to the invention, in section,

FIG. 4 a further development of a housing part for a galvanic cell according to the invention, in section,

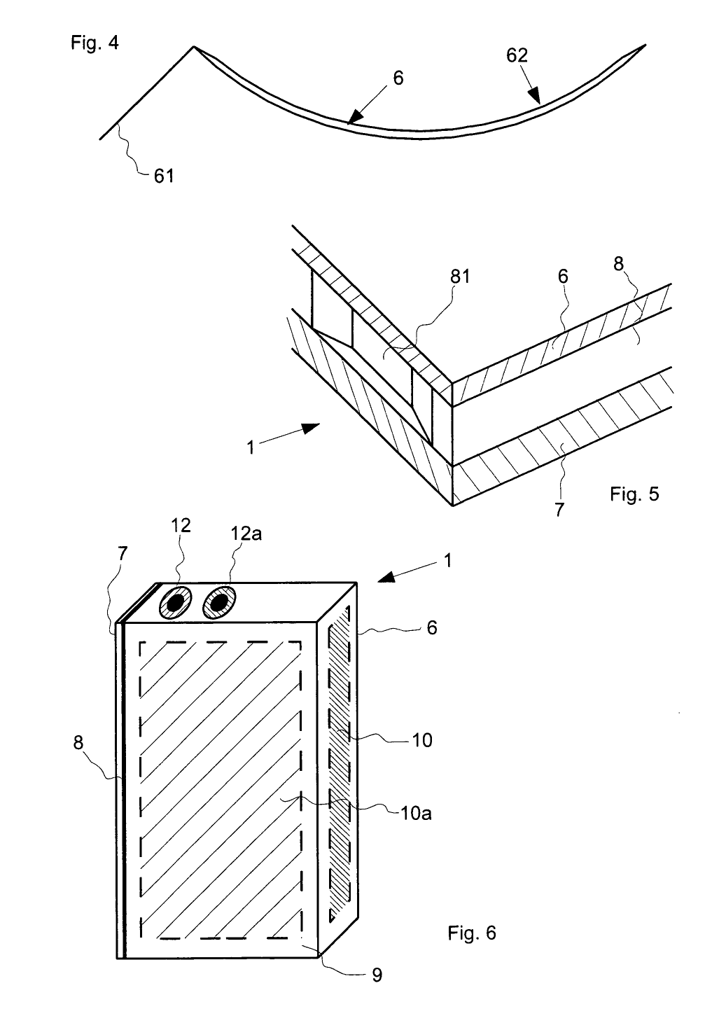

FIG. 5 a cut-out of a further development of a galvanic cell according to the invention, the assembly seam of which has a thin site or respectively predetermined breaking point,

FIG. 6 a perspective view of a further development of a galvanic cell according to the invention with a measurement device.

FIG. 1 shows a galvanic cell 1 according to the invention, the electrode stack 2 of which is enclosed by two housing parts 6, 7. The two housing parts 6, 7 are connected with each other by elastic assembly seams 8, 8a. Depending on the cut of the housing parts 6, 7, the latter may also be connected by a single continuous assembly seam. The electrode stack 2 is stacked from several anodes 3, 3a, several cathodes 4, 4a and several separators 5. Here, the electrodes 3, 3a, 4, 4a and the separators 5 are constructed as rectangular foils, wherein the separator foils 5 are dimensioned somewhat larger than the electrode foils. The electrode stack 2 is delimited by an anode 3a, and on the other side by a cathode 4. Although not illustrated in the figure, the housing parts 6, 7 are closed around the electrode stack 2 so that anode 3a adjoining these and cathode 4 adjoining these touch various housing parts 6, 7 in an electrically conductive and thermally conductive manner. The expandable assembly seams 8, 8a are constructed so that they draw together the two housing parts 6, 7 as a result of elastic restoring forces securely around the electrode stack 2. The two housing parts 6, 7 are braced against each other such that on failure of an assembly seam 8, 8a or on absence of an assembly seam 8, 8a they would move away from their predetermined positions in relation to the electrode stack 2. The housing parts 6, 7 are constructed so as to be congruent and complete each other to form a substantially block-shaped configuration. Here, the housing parts 6, 7 are dimensioned so that the space enclosed by them is smaller than the volume of the electrode stack 2. Even taking into consideration the dimensions of non-expanded assembly seams 8, 8a, the space enclosed by the housing parts 6, 7 is smaller than the volume of the electrode stack 2. Thus, after closing of the housing, the housing parts 6, 7 exert forces onto the electrode stack 2, which also press its individual layers onto each other.

FIG. 2 shows a further embodiment of a galvanic cell according to the invention, in section. Here, an anode 3 and a cathode 4 are constructed so that they are constructed as housing parts 6, 7 and also fulfil the functions thereof. Advantageously, in this embodiment, additional assemblies for the housing parts can be dispensed with. The housing parts 6, 7 formed by the electrodes 3, 4 are separated by a separator layer 5 and connected with expandable and elastic assembly seams 8, 8a. The elastic restoring forces within the expandable assembly seams 8, 8a bring it about that the electrodes 3, 4 enclose the separator 5 with a certain pressure. Thus, a good electrically conductive and thermally conductive contact exists between the individual layers. The electrodes 3, 4 could definitely enclose several separators 5 and further electrodes.

FIG. 3 shows a second further development of a galvanic cell 1 according to the invention. Here, also, the electrodes 3, 4 form at the same time two housing parts 6, 7. Here, the anode 3 and the cathode 4 are constructed having multiple layers. In particular, the further electrode layers 3a, 4a are connected electrically and in a thermoconducting manner via soldered connections with the electrodes 3, 4 forming the housing. The individual layers of the anode 3, 3a or respectively cathode 4, 4a are separated and spaced apart by separators 5. The anode 3 or respectively the cathode 4 are dimensioned so that they jointly exert a compressing pressure onto the electrode stack 2. The expandable assembly seams 8, 8a receive this pressure as a result of elastic restoring forces. The expandable assembly seams 8, 8a insulate the two housing parts 6, 7 or respectively electrodes 3, 4 from each other electrically.

FIG. 4 shows in section a housing part 6 in an unstressed state. A leg 62 of the housing part 6 is curved and is provided with a reinforcement rib. For better illustration, the bending radius is drawn in an exaggerated manner. With stretching, tensile and compressive stresses are produced in the leg 62, which urge the leg 62 back into its original configuration. This effort towards curvature of the leg 62 produces, on lying against the electrode stack which is not shown, a force which presses the layers of the electrode stack onto each other.

FIG. 5 shows a cut-out of a galvanic cell 1 according to the invention, wherein its assembly seam 8 has a thin site or respectively predetermined breaking point 81. The thin site 81 is dimensioned so that a large opening is produced, through which an excess pressure in the cell interior can be reduced efficiently. The thin site 81 is arranged at an upper region of the galvanic cell 1 so that predominantly gases can escape.

FIG. 6 shows a galvanic cell 1 according to the invention, with a measurement device. The measurement device, here a thermal element, is arranged within the housing of the galvanic cell 1 and is not illustrated in the figure. Housing part 6 is connected with housing part 7 in a materially bonded manner by means of an expandable assembly seam 8. The assembly seam 8 is formed as an adhesive connection. The housing part 6 has several contact regions 10, 10a, 12, 12a. A first contact region 10 serves for the transmission of electrical energy. A first contact region 10a serves for the transmission of thermal energy. The second contact regions 12 and 12a serve for the contacting of the thermal element, which is not illustrated. The illustrated embodiment of a galvanic cell 1 according to the invention makes possible its permanent operation, avoiding the occurrence of defects in tightness of feedthroughs.

1. Galvanic cell (1) substantially prismatic in design, comprising: an electrode stack (2) having at least one anode (3, 3a), one cathode (4, 4a) and one separator (5), the separator being provided for at least partially receiving an electrolyte, at least two housing parts (6, 7), provided for at least partially enclosing the electrode stack (2),
at least one assembly seam (8, 8a), provided to connect the at least two housing parts (6, 7) at least in parts,
characterized in that
the at least one assembly seam (8, 8a) is configured so as to be expandable.

2. Galvanic cell (1) according to claim 1, characterized in that at least one anode (3) touches at least in parts one of the at least two housing parts (6, 7) in an electrically conductive and thermally conductive manner, and that at least one cathode (4) touches at least in parts the other of the at least two housing parts (6, 7) in an electrically conductive and thermally conductive manner.

3. Galvanic cell (1) according to claim 1, characterized in that at least one anode (3) is constructed as one of the at least two housing parts (6, 7) and that at least one cathode (4) is constructed as the other of the at least two housing parts (6, 7).

4. Galvanic cell (1) according to at least one of the preceding claims, characterized in that the at least one assembly seam (8, 8a) is designed to fail in a predetermined manner.

5. Galvanic cell (1) according to at least one of the preceding claims, characterized in that at least one of the at least two housing parts (6, 7) has at least one boundary surface (9) and at least one first contact region (10, 10a), wherein the at least one first contact region (10, 10a) is arranged in particular on the at least one boundary surface (9).

6. Galvanic cell (1) according to at least one of the preceding claims, characterized in that the at least two housing parts (6, 7) are provided for joining and that the at least two housing parts (6, 7) are tensioned against each other after joining.

7. Galvanic cell (1) according to at least one of the preceding claims, characterized in that at least one of the at least two housing parts (6, 7) is provided, to be transferred from an unstressed state into a tensioned state.

8. Galvanic cell (1) according to at least one of the preceding claims, characterized in that in addition at least one measurement device (11), in particular a temperature measurement device (11a) is associated with the galvanic cell (1).

9. Galvanic cell (1) according to claim 8, characterized in that the at least one measurement device (11) is connected, in particular in an electrically conductive manner, with at least one second contact region (12, 12a).

10. Method for the production of a galvanic cell (1) according to at least one of the preceding claims, with the steps:
a) producing the electrode stack (2),
b) arranging the at least two housing parts (6, 7) around the electrode stack (2),
c) compressing the at least two housing parts (6, 7),
d) producing the at least one assembly seam (8, 8a).

11. Method according to claim 10 for the production of a galvanic cell (1) according to at least one of claims 1-9, characterized in that before step d) an underpressure is produced within the space enclosed by the at least two housing parts (6, 7).

12. Method according to claim 10 or 11 for the production of a galvanic cell (1) according to claim 7, characterized in that before step d) at least one of the at least two housing parts (6, 7) is transferred from an unstressed state into a tensioned state.

13. Method for the operation of a galvanic cell (1) according to at least one of claims 1-9, that at least one assembly seam (8, 8a) fails under predetermined conditions in a predetermined manner and in particular allows the partial exit of the content of the galvanic cell (1).

14. Method for the operation of a galvanic cell (1) according to at least one of claims 1-9, that thermal energy is removed from at least one of the at least two housing parts (6, 7) under predetermined conditions.
